(19) United States
(12) Patent Application Publication
(10) Pub. No.: US 2025/0130177 A1
(43) Pub. Date: Apr. 24, 2025

(54) ELECTRODE ASSEMBLY ALIGNMENT INSPECTION APPARATUS AND METHOD

(71) Applicant: SK ON CO., LTD., Seoul (KR)

(72) Inventors: Ji-Won YANG, Daejeon (KR); Young-Rae OH, Daejeon (KR); Jae-Young JUNG, Daejeon (KR)

(21) Appl. No.: 18/725,977

(22) PCT Filed: Dec. 29, 2022
(86) PCT No.: PCT/KR2022/021617

§ 371 Date: Jul. 1, 2024

(30) Foreign Application Priority Data
Dec. 29, 2021 (KR) 10-2021-0191066
Dec. 28, 2022 (KR) 10-2022-0186558

(51) Int. Cl. G01N 21/88; H01M 10/04

(52) U.S. Cl. CPC G01N 21/8851; G01N 21/8806; H01M 10/0404; H01M 10/0459; G01N 2201/021

(57) ABSTRACT

An electrode assembly alignment inspection apparatus according to one embodiment of the present disclosure comprises: a stacking table to which an electrode assembly including an electrode plate and a separator is supplied; a holder disposed on the stacking table to support an edge region of the electrode plate and the separator; an photographing unit photographing the electrode plate and the separator supplied to the stacking table; and a lighting unit irradiating light to the stacking table, wherein the holder includes a plurality of holes exposing a boundary between the electrode plate and the separator, and the lighting unit includes an auxiliary lighting disposed on the stacking table to illuminate portions exposed through the plurality of holes.

### TECHNICAL FIELD

The present disclosure relates to an electrode assembly alignment inspection apparatus and an electrode assembly alignment inspection method using the same.

### BACKGROUND ART

A secondary battery refers to a battery that can be repeatedly charged and discharged since mutual conversion between chemical energy and electrical energy is reversible.

The secondary battery may be used as an energy source for an electric vehicle, a hybrid vehicle, and an energy storage system (ESS), which has recently attracted attention, including a mobile device.

The secondary battery may be broadly divided into a cylindrical battery, a prismatic battery, a pouch-shaped battery, and the like, depending on the external shape thereof, and the shape of the electrode assembly contained therein may vary depending on the external shape thereof.

The electrode assembly is a structure in which a separator is rolled or stacked between a cathode plate and an anode plate, and may be classified into a structure (jelly roll type) formed by winding a long sheet of the cathode plate, the anode plate, and the separator, interposed therebetween, and a structure (stack type) formed by sequentially stacking the cathode plate and the anode plate, cut to a predetermined size, with the separator interposed therebetween.

Meanwhile, in the stack-type electrode assembly, since the cathode plate and the anode plate are sequentially stacked, a position in which the cathode and anode plates are aligned is very important. If the position is even slightly misaligned during the stacking process, it can cause a short circuit and cause a fire, so the importance of an apparatus for inspecting an alignment state of the electrode assembly is increasing.

### SUMMARY OF INVENTION

### Technical Problem

An aspect of the present disclosure is to provide an electrode assembly alignment inspection apparatus and an electrode assembly alignment inspection method that can inspect an alignment state of a cathode plate, an anode plate, and a separator.

An aspect of the present disclosure is to provide an electrode assembly alignment inspection apparatus and an electrode assembly alignment inspection method that can obtain a clear image without affecting the quality of the electrode assembly.

### Solution to Problem

According to an aspect of the present disclosure, an electrode assembly alignment inspection apparatus is provided, wherein the electrode assembly alignment inspection apparatus may include: a stacking table to which an electrode assembly including an electrode plate and a separator is supplied; a holder disposed on the stacking table to support an edge region of the electrode plate and the separator; an photographing unit photographing the electrode plate and the separator supplied to the stacking table; and a lighting unit irradiating light to the stacking table, wherein the holder may include a plurality of holes exposing a boundary between the electrode plate and the separator, and the lighting unit may include auxiliary lighting disposed on the stacking table to illuminate a portion of the lighting unit, exposed through the plurality of holes.

According to an embodiment of the present disclosure, the holder may be disposed to support at least the electrode plate and the separator on both sides in a longitudinal direction.

According to an embodiment of the present disclosure, the holder may include a light-transmitting transparent member disposed in the plurality of holes.

According to an embodiment of the present disclosure, the stacking table may include a plurality of insertion holes into which the auxiliary lighting is inserted, and the holder may be disposed on the stacking table so that the plurality of holes overlap the plurality of insertion holes.

According to an embodiment of the present disclosure, the holder may include a first hole exposing a boundary between the electrode plate and the separator in a longitudinal direction; and a second hole exposing a boundary between the electrode plate and the separator in a width direction, wherein the second hole may include a portion of the electrode plate and the separator, open in the width direction.

According to an embodiment of the present disclosure, the stacking table may include a first insertion hole overlapping the first hole; and a second insertion hole overlapping the second hole, wherein the first insertion hole and the second insertion hole may be formed to have an area larger than that of the first hole and the second hole, respectively.

According to an embodiment of the present disclosure, an electrode assembly alignment inspection method may include a supply operation of supplying an electrode plate and a separator to an electrode table into which auxiliary lighting is inserted; a support operation of supporting the electrode plate and the separator by disposing a holder on the stacking table; an photographing operation in which an photographing unit photographs an edge region of the electrode plate and the separator; and a determination operation of inspecting an alignment state of the electrode plate and the separator to determine whether the alignment state is defective, wherein the holder may include a plurality of holes exposing a boundary between the electrode plate and the separator, and in the support operation, the holder may be disposed on the stacking table so that the plurality of holes overlap a position into which the auxiliary lighting is inserted.

According to an embodiment of the present disclosure, in the support operation, the holder may be disposed on the stacking table to support at least the electrode plate and the separator on both sides in a longitudinal direction.

According to an embodiment of the present disclosure, the holder may include a first hole exposing a boundary between the electrode plate and the separator in a longitudinal direction; and a second hole exposing a boundary between the electrode plate and the separator in a width direction and including a portion of the electrode plate and the separator, open in the width direction, and in the support operation, the holder may be disposed so that the open portion of the second hole coincides with the boundary of the separator.

According to an embodiment of the present disclosure, in the determination operation, when the alignment state of the electrode plate and the separator is determined to be defective, the supply of the electrode plate and the separator may be stopped.

According to an embodiment of the present disclosure, the electrode plate may include a cathode plate and an anode plate, and in the supply operation, the cathode plate and the anode plate may be alternately supplied to the stacking table with the separator interposed therebetween.

According to an embodiment of the present disclosure, the support operation and the photographing operation may be performed with the cathode plate disposed in the uppermost position based on a stacking direction of the stacking table.

According to an embodiment of the present disclosure, the photographing unit may be provided in a number corresponding to the number of holders, and the photographing operation may be performed on one or more regions in which the holder is disposed.

According to an embodiment of the present disclosure, the determination operation may include an operation of recognizing a boundary of the anode plate from the image photographed in the photographing operation, wherein, when the boundary of the anode plate is not recognized, the alignment state of the electrode plate and the separator may be determined to be defective.

According to an embodiment of the present disclosure, the determination operation may include an operation of measuring a gap between a boundary of the anode plate and a boundary of the separator from the image photographed in the photographing operation, wherein, when the gap between the boundary of the anode plate and the boundary of the separator exceeds a preset range, the alignment state of the electrode plate and the separator may be determined to be defective.

According to an embodiment of the present disclosure, the determination operation may include an operation of measuring a gap between a boundary of the anode plate and a boundary of the cathode plate from the image photographed in the photographing operation, wherein, when the gap between the boundary of the anode plate and the boundary of the cathode plate exceeds a preset range, the alignment state of the electrode plate and the separator may be determined to be defective.

### Advantageous Effects of Invention

As set forth above, according to an embodiment of the present disclosure, an alignment state of a cathode plate, an anode plate, and a separator may be inspected during the manufacturing process, thereby improving the quality reliability of an electrode assembly.

In addition, according to an embodiment of the present disclosure, a clear image may be obtained without affecting the quality of the electrode assembly, thereby increasing the accuracy of determining defectiveness.

### BRIEF DESCRIPTION OF DRAWINGS

Certain aspects, features, and advantages of the present disclosure are illustrated by the following detailed description with reference to the accompanying drawings.

FIG. 1 is a diagram illustrating a conventional electrode assembly alignment inspection apparatus.

FIG. 2 is a diagram illustrating an electrode assembly alignment inspection apparatus according to an embodiment of the present disclosure.

FIG. 3 is a diagram illustrating a position in which the holder of FIG. 2 is disposed.

FIG. 4 is an enlarged view of a first hole and a second hole according to an embodiment of the present disclosure.

FIG. 5 is a diagram illustrating the first hole, the second hole, and the insertion hole of FIG. 4.

FIG. 6A is an image photographed using the conventional electrode assembly alignment inspection apparatus shown in FIG. 1, and FIG. 6B is an image photographed using the electrode assembly alignment inspection apparatus according to an embodiment of the present disclosure shown in FIG. 2.

FIG. 7 is a flowchart of an electrode assembly alignment inspection method according to an embodiment of the present disclosure.

FIGS. 8A to 8C are diagrams illustrating a method of supplying a cathode plate, an anode plate, and a separator.

FIG. 9 is a diagram for illustrating a determination operation of the electrode assembly alignment inspection method according to an embodiment of the present disclosure.

### MODE FOR INVENTION

Hereinafter, embodiments of the present disclosure will be described in detail with reference to the attached drawings. However, the spirit of the present disclosure is not limited to the examples below.

For example, a person skilled in the art who understands the spirit of the present disclosure will be able to suggest other embodiments included within the scope of the spirit of the present disclosure through the addition, change, or deletion of components, but this is also within the spirit of the present invention, but which will be said to be included within the scope of the idea of the present disclosure.

The present disclosure relates to an electrode assembly alignment inspection apparatus that can inspect an alignment state of electrode plates and a separator during a process of manufacturing an electrode assembly, wherein in the process, electrode plates (a cathode plate and an anode plate) and a separator are sequentially stacked and an electrode assembly alignment inspection method using the same.

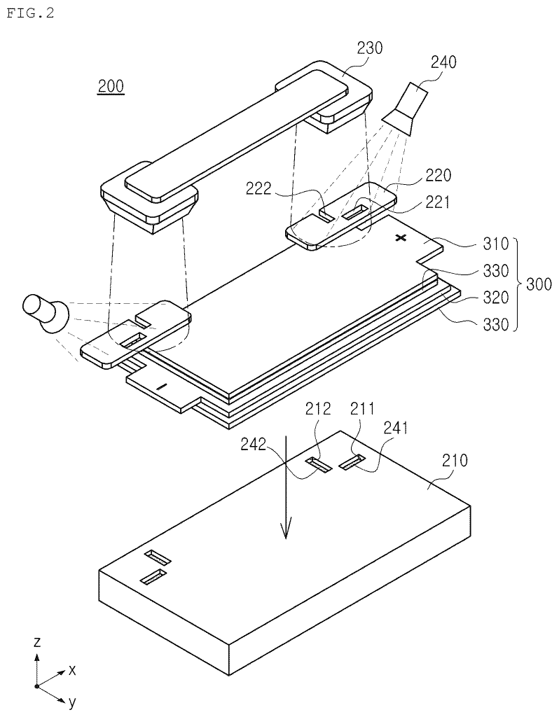

FIG. 2 is a view illustrating an electrode assembly alignment apparatus according to an embodiment of the present disclosure.

According to an embodiment of the present disclosure, an electrode assembly alignment inspection apparatus 200 may include a stacking table 210, a holder 220, a photographing unit 230, and a lighting unit 240.

A cathode plate 310, an anode plate 320 (or electrode plates 310 and 320), and a separator 330, forming an electrode assembly 300 may be supplied to the stacking table 210. The stacking table 210 may refer to a structure including a flat surface so that the electrode plates 310 and 320 and the separator 330 may be stacked without damage.

The electrode assembly 300 may have the cathode plate 310 and the anode plate 320 stacked alternately with the separator 330 interposed therebetween, and the electrode plates 310 and 320 and the separator 330 may be alternately supplied to the stacking table 210. For example, the separator 330, the anode plate 320 (or cathode plate 310), the separator 330, and the cathode plate 310 (or anode plate 320) may be sequentially supplied and stacked on the stacking table 210.

The holder 220 may be disposed on the stacking table 210 to support the electrode plates 310 and 320 and the separator 330 supplied to the stacking table 210. The holder 220 may be disposed to support an edge region of the electrode plates 310 and 320 and the separator 330.

The holder 220 may be provided in plural, and may be disposed to be spaced apart in a longitudinal direction and/or a width direction of the electrode plates 310 and 320 and the separator 330 to support the edge areas of the electrode plates 310 and 320 and the separator 330. In an embodiment, the plurality of holders 220 may be disposed to be spaced apart from each other in the longitudinal direction of the electrode plates 310 and 320 and the separator 330 to support around corners on both sides of the electrode plates 310 and 320 and the separator 330 in the longitudinal direction. In another embodiment, the plurality of holders 220 may be spaced apart from each other in the longitudinal and width directions of the electrode plates 310 and 320 and the separator 330 to support around all corners of the electrode plates 310 and 320 and the separator 330.

The holder 220 may include a first hole 221 and a second hole 222 penetrating the holder 220 in a thickness direction. The first hole 221 and the second hole 222 may expose a photographing region, that is, the boundary between the electrode plates 310 and 320 and the separator 330. Accordingly, even when the holder 220 supports the edge region of the electrode plates 310 and 320 and the separator 330, the photographing region is exposed externally, so photographing may be possible by a photographing unit 230, which will be described later.

The photographing unit 230 may be disposed to face the stacking table 210 in a stacking direction (or Z-direction) of the electrode plates 310 and 320 and the separator 330, to photograph the alignment state of the electrode plates 310 and 320 and the separator 330. For example, the photographing unit 230 may be a camera or the like.

The photographing unit 230 may be disposed on an upper side of the stacking table 210, and may be preferably provided in a number corresponding to the number of holders 220 and may be disposed on an upper side of each of the holders 220 so that the photographing region exposed through the first hole and the second hole is visible.

The lighting unit 240 may irradiate light to the stacking table 210 supplied with the electrode plates 310 and 320 and the separator 330 so that the photographing unit 230 can obtain a clear image.

According to an embodiment of the present disclosure, the lighting unit 240 may be disposed on at least the stacking table 210. Hereinafter, auxiliary lighting 241 and 242 may refer to the lighting unit 240 disposed on the stacking table 210.

The auxiliary lighting 241 and 242 may be provided in plural, and may be disposed on the stacking table 210. The stacking table 210 may include a plurality of insertion holes 211 and 212 into which the auxiliary lighting 241 and 242 are inserted. For example, the auxiliary lighting 241 and 242 may be LED lights, and an upper plate of the stacking table 210 to which the electrode plates 310 and 320, or the like, are supplied may be formed of a light-transmitting material.

The insertion holes 211 and 212 may be formed in a position corresponding to the first hole 221 and the second hole 222 formed in the holder 220. In other words, the holder 220 may be disposed on the stacking table 210 so that the first hole 221 and the second hole 222 formed in the holder 220 overlap the insertion holes 211 and 212. Accordingly, the auxiliary lighting 241 and 242 inserted into the insertion holes 211 and 212 may illuminate the first hole 221 and the second hole 222, and the boundary between the electrode plates 310 and 320 and the separator 330 exposed through the first hole 221 and the second hole 222 may be clear.

The electrode assembly alignment inspection apparatus 200 performs photographing while the electrode plates 310, 320 and the separator 330 are fixed and supported by the holder 220, so that a clear image may be obtained, and photographing accuracy may be improved.

Since the auxiliary lighting 241 and 242 inserted into the stacking table 210 illuminate the boundary between the electrode plates 310 and 320 and the separator 330, the photographing area may be brighter. In particular, since both the upper plate of the stacking table 210 and the separator 330 are transparent at the beginning of stacking, a phenomenon in which the boundary of the anode plate 320 (or the cathode plate 310) appears blurry may be improved.

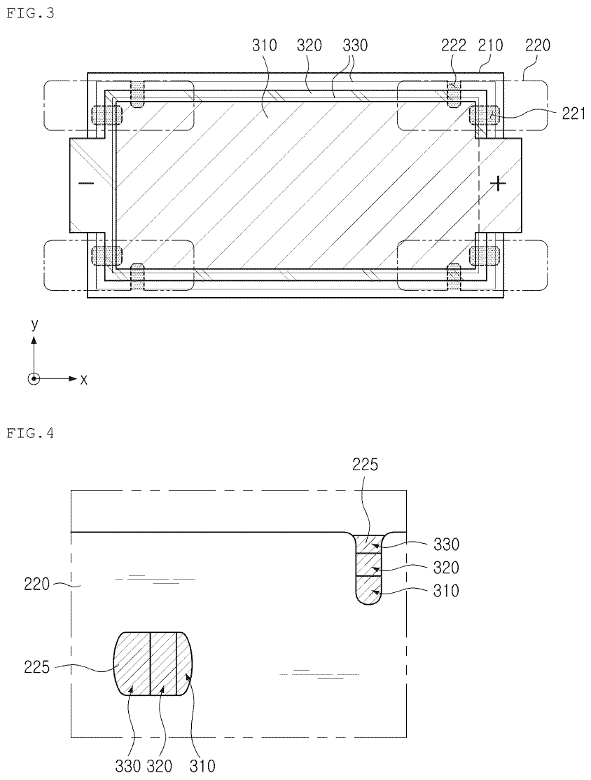

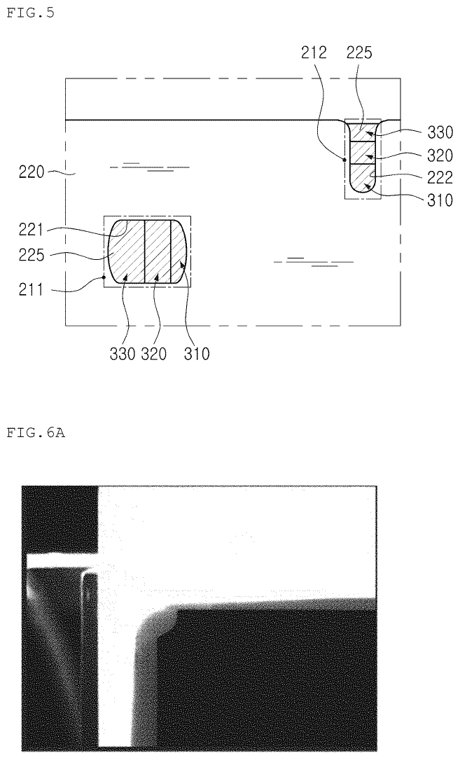

Hereinafter, the holder 220 of the electrode assembly alignment inspection apparatus 200 according to an embodiment of the present disclosure will be described in detail with reference to FIGS. 3 and 4.

FIG. 3 is a diagram illustrating a position in which the holder of FIG. 2 is disposed, and FIG. 4 is an enlarged view of a first hole and a second hole according to an embodiment of the present disclosure.

According to an embodiment of the present disclosure, the holder 220 may be disposed on the stacking table 210 to support the electrode plates 310 and 320 and the separator 330. Accordingly, the electrode plates 310, 320 and the separator 330 supplied to the stacking table 210 may be photographed to inspect the alignment state while the electrode plates 310 and 320 and the separator 330 are fixed.

The holder 220 may support an edge region of the electrode plates 310 and 320 and the separator 330. In this case, the edge region may include a boundary between the electrode plates 310 and 320 and the separator 330 and a peripheral portion thereof. For example, the holder 220 may be disposed on both sides of the electrode plates 310 and 320 in the longitudinal direction, respectively, as illustrated in FIG. 2, or may be disposed around all corners of the electrode plates 310 and 320, respectively, as illustrated in FIG. 3.

Meanwhile, the holder 220 may include a first hole 221 and a second hole 222 exposing a photographing region. The first hole 221 and the second hole 222 may be small-sized holes processed to expose only the photographing region, that is, the boundary portion of the electrode plates 310 and 320 and the separator 330.

As described above, since the boundary between the electrode plates 310 and 320 and the separator 330 are exposed through the first hole 221 and the second hole 222 formed in the holder 220, even when the electrode plates 310 and 320 and the separator 330 are suppressed by the holder 220, the boundary between the electrode patterns 310 and 320 and the separator 330 may be photographed.

Referring to FIGS. 3 and 4, the first hole 221 may expose the boundary between the electrode plates 310 and 320 and the separator 330 in the longitudinal direction (or x direction), and the second hole 222 may expose the boundary between the electrode patterns 310 and 320 and the separator 330 in a width direction (or y direction).

The first hole 221 may be formed in a shape extending in the longitudinal direction of the electrode plates 310 and 320 and the separator 330, and the second hole 222 may be formed in a shape extending in the width direction of the electrode plates 310 and 320 and the separator 330. Accordingly, the boundary between the cathode plate 310, the anode plate 320, and the separator 330 in the longitudinal direction may be all exposed through the first hole 221, and the boundary between the cathode plate 310, the anode plate 320, and the separator 330 in the width direction may all be exposed through the second hole 222. In addition, a gap between the cathode plate 310, the anode plate 320, and the separator 330 may be confirmed by photographing the exposed boundary through the first hole 221 and the second hole 222.

In addition, referring to FIGS. 3 and 4, the first hole 221 may be formed inside the holder 220, and the second hole 222 may be formed in the boundary portion of the holder 220. For example, the second hole 222 may be formed in an open shape toward the boundary between the electrode plates 310 and 320 and the separator 330 in the width direction.

The holder 220 may be disposed so that the open portion of the second hole 222 coincides with the boundary of the separator 330, and accordingly, the boundary of the transparent separator 330 can be confirmed through position of the holder 220. In particular, since the boundary of the separator 330 that coincides with the open portion of the second hole 222 is a folded section of the separator 330, the second hole 222 may be processed to have a substantially narrow width to prevent damage such as folding or tearing of the separator 330.

Meanwhile, as illustrated in FIG. 4, a light-transmitting transparent member 225 may be disposed in the first hole 221 and the second hole 222. When the transparent member 225 is disposed in the first hole 221 and the second hole 222, the electrode plates 310 and 320 may not be exposed externally, so the impact on quality can be minimized.

According to an embodiment of the present disclosure, even if the holder 220 is disposed to overlap the electrode patterns 310 and 320 and the separator 330 during the manufacturing process of the electrode assembly 300, damage to the electrode plates 310 and 320 and the separator 330 caused by the holder 220 may be prevented, the quality of the electrode assembly 300 may be maintained.

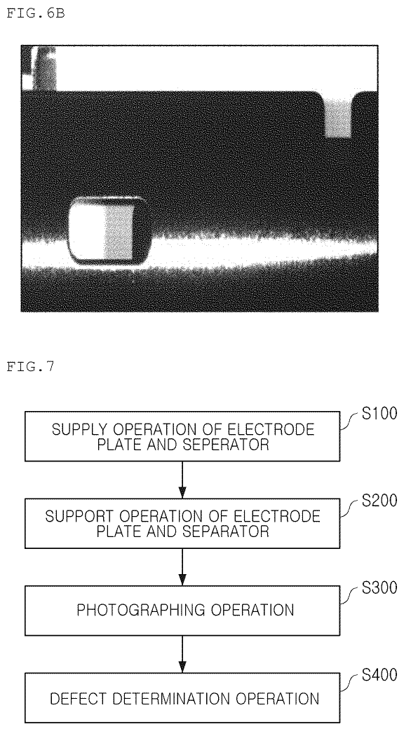

FIG. 5 is a diagram illustrating the first hole, the second hole, and the insertion hole of FIG. 4.

As described above, the stacking table 210 may include a plurality of insertion holes 211 and 212 into which the auxiliary lighting 241 and 242 are inserted. The holder 220 may be disposed on the stacking table 20 so that the first hole 221 and the second hole 222 overlap the plurality of insertion holes 211 and 212.

Referring to FIG. 5, the stacking table 210 may include a first insertion hole 211 overlapping the first hole 221 and a second insertion hole 212 overlapping the second hole 222. The first insertion hole 211 may be formed in a shape extending in a longitudinal direction of the electrode plates 310 and 320 and the separator 330, as illustrated in the first hole 221, and the second insertion hole 212 may be formed in a shape extending in a width direction of the electrode plates 310 and 320 and the separator 330, as illustrated in the second hole 222.

The holder 220 may be disposed on the stacking table 210 so that the first hole 221 and the second hole 222 coincide with centers of the first insertion hole 211 and the second insertion hole 212, respectively.

According to an embodiment of the present disclosure, the first insertion hole 211 may be formed to have a larger area than the first hole 221. For example, the area of the first insertion hole 211 may be determined based on a preset gap between the cathode plate 310, the anode plate 320, and the separator 330, and may further be formed to have a larger area than the area of the first hole 221. Preferably, the first insertion hole 211 may be formed to have an area of approximately 120% of the area of the first hole 221.

Relative sizes of the first insertion hole 211 and the first hole 221 determined in this manner may minimize a light blurring phenomenon caused by the auxiliary lighting 241, and a brightness contrast of the boundary between the electrode plates 310 and 320 and the separator 330 can be maximized.

Since the second hole 222 is a portion in which folding of the separator 330 occurs, the second hole 222 may be formed to have a width and size that does not cause quality problems such as folding or tearing of the separator 330.

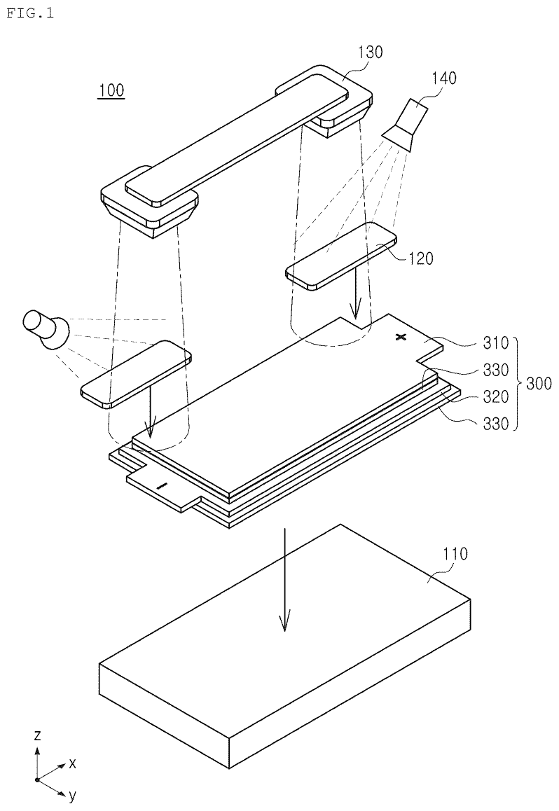

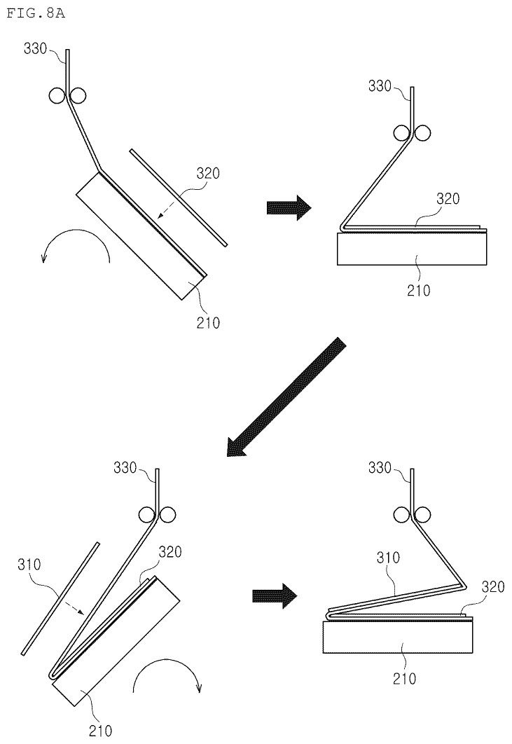

FIG. 6A is an image photographed using the conventional electrode assembly alignment inspection apparatus shown in FIG. 1, and FIG. 6B is an image photographed using the electrode assembly alignment inspection apparatus according to an embodiment of the present disclosure shown in FIG. 2.

In the image of FIG. 6A, the boundary of the electrode plates 310 and 320 at the time of stacking appear blurred due to the light blurring phenomenon, while in the image of FIG. 6B, it can be checked that the boundary of the electrode plates 310 and 320 at the time of stacking appear clearly.

As described above, the electrode assembly alignment inspection apparatus 200 according to an embodiment of the present disclosure may irradiate light from below the photographing area, thereby forming a brightness contrast and obtaining an image with a clear boundary by additionally disposing auxiliary lighting units 241 and 242 on the stacking table 210.

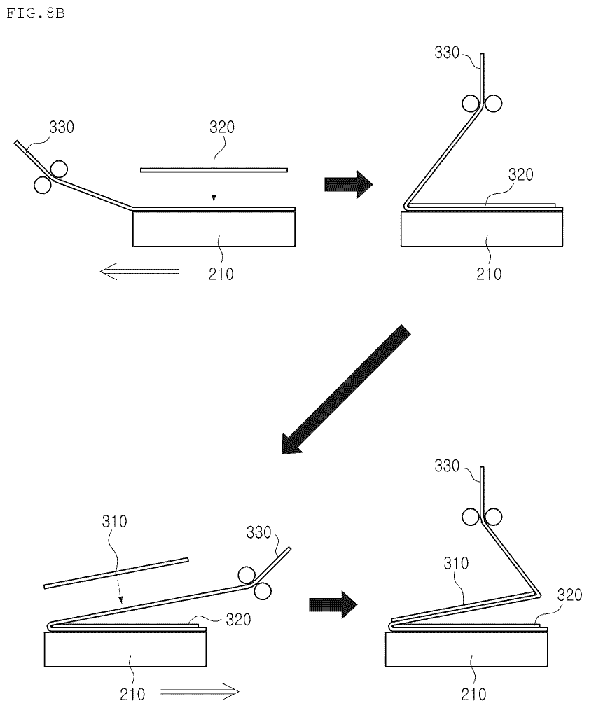

FIG. 7 is a flowchart of an electrode assembly alignment inspection method according to an embodiment of the present disclosure.

According to an embodiment of the present disclosure, the electrode assembly alignment inspection method may include a supply operation (S100) of electrode plates 310 and 320 and a separator 330, a support operation (S200) of the electrode plates 310 and 320 and the separator 330, a photographing operation (S330), and a defect determination operation (S400).

The supply operation (S100) of the electrode plates 310 and 320 and the separator 330 (hereinafter, referred to as a supply operation) may be an operation in which the electrode plates 310 and 320 and the separator 330 are provided to the stacking table 210. The cathode plate 310 and the anode plate 320 may be alternately provided and stacked on the stacking table 210 with the separator 330 interposed therebetween.

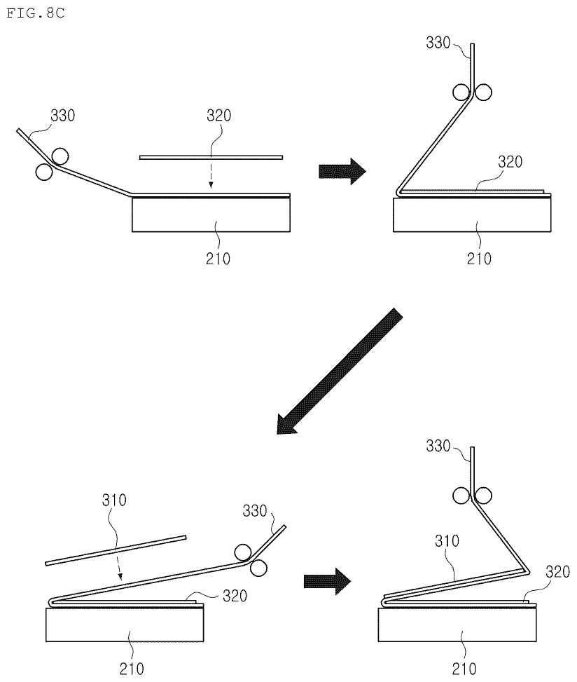

FIGS. 8A to 8C are diagrams illustrating a method of supplying a cathode plate, an anode plate, and a separator.

Referring to FIG. 8A, a stacking table 210 may be configured to be rotated to the left and right. For example, the stacking table 210 may rotate left and right approximately 45 degrees, and an anode plate 320 (or a cathode plate 310) may be supplied while the stacking table is rotated to the right (or left), and the cathode plate 310 (or the anode plate 320) may be supplied while the stacking table 210 is rotated to the left (or right). While the stacking table 210 rotates, a separator 330 may be continuously supplied and interposed between the cathode plate 310 and the anode plate 320, which are alternately stacked. The separator 330 may not be supplied by being cut to a predetermined size like the cathode plate 310 and the anode plate 320, but may be supplied in long zigzag sheets.

Referring to FIG. 8B, the stacking table 210 may be configured to move left and right in parallel. For example, the anode plate 310 (or cathode plate 310) may be supplied while the stacking table 210 is moved to the right (or left), and the cathode plate 310 (or anode plate 320) may be supplied while the stacking table 210 is moved to the left (or right). While the stacking table 210 is moved, the separator 330 may be continuously supplied and interposed between the cathode plate 310 and the anode plate 320, which are alternately stacked.

Referring to FIG. 8C, the stacking table 210 may be configured to remain fixed in a specific position. For example, the stacking table 210 may be fixedly provided between a cathode plate providing unit (not shown) and an anode plate providing unit (not shown), and the cathode plate providing unit and the anode plate providing unit may be moved to a fixed position to supply the cathode plate 310 and the anode plate 320. The separator 330 may be continuously supplied to the stacking table 210 and interposed between the cathode plate 310 and the anode plate 320, which are alternately stacked.

As described above, the electrode assembly alignment inspection method according to an embodiment of the present disclosure may be applied regardless of the supply method of the electrode plates 310 and 320.

The support operation of the electrode plates 310, 320 and separator 330 (hereinafter, referred to as a support operation) (S200) may be an operation of supporting an edge region of the electrode plates 310, 320, or the like, supplied to the stacking table 210 with the holder 220.

The holder 220 may be disposed above the anode plate 320 or the cathode plate 310 provided on the separator 330. The holder 220 may be disposed on both sides or all corners of the electrode plates 310 and 320 in the longitudinal direction. In addition, with the holder 220 disposed, a boundary between the cathode plate 310, the anode plate 320, and the separator 330 may be exposed through a first hole 221 and a second hole 222 formed in the holder 220. The holder 220 may be disposed so that the first hole 221 exposes a boundary between the electrode plates 310 and 320 and the separator 330 in a longitudinal direction, and the second hole 222 exposes a boundary between the electrode plates 310 and 320 and the separator 330 in a width direction. In addition, in this case, the second hole may be disposed so that an open portion of the second hole 222 coincides with the boundary of the separator 330.

The photographing operation (S300) is an operation of photographing the boundary of the cathode plate 310, the anode plate 320, and the separator 330 exposed through the first hole 221 and the second hole 222, and may be performed with the lighting unit 240 irradiating light. According to an embodiment of the present disclosure, the photographing operation (S300) may be performed with the electrode plates 310 and 320 supported by the holder 220.

The photographing operation (S300) may be performed after the anode plate 320 and the cathode plate 310 are supplied on the separator 330. For example, electrode plates 310 and 320, or the like, may be supplied to the stacking table 210 in the following order: the separator 330—the anode plate 320—the separator 330—the cathode plate 310, and by performing photographing while the cathode plate 310 is supplied to the separator 330, the gap between the anode plate 320 and the separator 330 and the gap between the anode plate 320 and the cathode plate 310 can be measured.

Meanwhile, according to an embodiment of the present disclosure, the stacking table 210 may include a first insertion hole 211 and a second insertion hole 212, into which auxiliary lighting 241 and 242 are inserted in a position corresponding to that of the first hole 221 and the second hole 222.

According to an embodiment of the present disclosure, since the auxiliary lighting 241 and 242 irradiate light to the photographing region while the electrode plates 310 and 320 and the separator 330 are pressed and fixed by the holder 220, it is possible to prevent the image from appearing blurry due to a lifting phenomenon of the boundary portion, and by forming a brightness contrast, a clear image can be obtained.

The defect determining operation (hereinafter referred to as the determination operation) (S400) is an operation of determining whether the electrode assembly 300 is defective based on the image photographed in the photographing operation. When the gap between the boundary of the electrode plates 310 and 320 and the boundary of the separator 330 from the image measured from the image photographed in the photographing operation, and the measured gap exceeds an error range, or the boundary is not recognized from the photographed image, which can be determined to be defective.

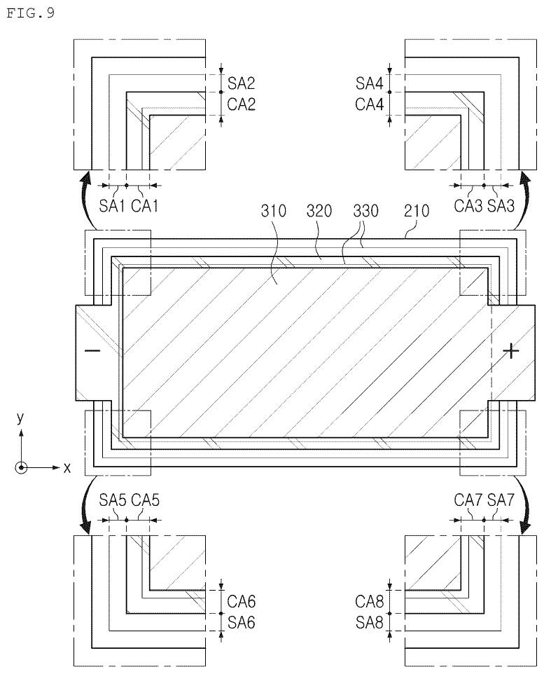

FIG. 9 is a diagram for illustrating a determination operation of the electrode assembly alignment inspection method according to an embodiment of the present disclosure.

In the determination operation (S400), a boundary of the anode plate 320 may be recognized, and a gap (SA) between the boundary of the anode plate 320 and the boundary of the separator 330, and a gap (CA) between the boundary of the anode plate 320 and the boundary of the cathode plate 310 may be measured. Since the boundary of the separator 330 coincides with the boundary of the open portion of the second hole 222, the recognition of the boundary of the separator 330 may be replaced with recognition of the open portion of the second hole 222.

The boundary of the anode plate 320 may be exposed through the first hole 221 and the second hole 222. For example, as illustrated in FIG. 9, when the holder 220 is disposed at each corner of the electrode plates 310 and 320, the boundary of the anode plate 320 may be exposed through eight holes, and if the boundary of the anode plate 320 is not recognized in one or more of the eight holes, the electrode assembly 300 may be determined to be defective.

The gap (SA) between the boundary of the anode plate 320 and the boundary of the separator 330 and the gap (CA) between the boundary of the anode plate 320 and the boundary of the cathode plate 310 may also be exposed through the first hole 221 and the second hole 222. In detail, the gap in each longitudinal direction may be confirmed through the first hole 221, and the gap in each width direction may be confirmed through the second hole 222.

In the case of the gap (SA) between the boundary of the anode plate 320 and the boundary of the separator 330 and the gap (CA) between the boundary of the anode plate 320 and the boundary of the cathode plate 310, if an error range exceeds a preset error range based on a center value, the electrode assembly 300 may be determined to be defective. According to an embodiment of the present disclosure, the determination operation (S400) may be performed during the manufacturing process of the electrode assembly 300, and when the electrode assembly 300 is determined to be defective, the supply of the electrode plates 310, 320 and the separator 330 may be stopped.

Only specific examples of implementations of certain embodiments are described. Variations, improvements and enhancements of the disclosed embodiments and other embodiments may be made based on the disclosure of this patent document.

While exemplary embodiments have been illustrated and described above, it will be apparent to those skilled in the art that modifications and variations could be made without departing from the scope of the present invention as defined by the appended claims.

What is claimed is:

1. An electrode assembly alignment inspection apparatus, comprising:
a stacking table to which an electrode assembly including an electrode plate and a separator is supplied;
a holder disposed on the stacking table to support an edge region of the electrode plate and the separator;
a photographing unit photographing the electrode plate and the separator supplied to the stacking table; and
a lighting unit irradiating light to the stacking table,
wherein the holder includes a plurality of holes exposing a boundary between the electrode plate and the separator, and
the lighting unit includes auxiliary lighting disposed on the stacking table to illuminate a portion of the lighting unit, exposed through the plurality of holes.

2. The electrode assembly alignment inspection apparatus of claim 1, wherein the holder is disposed to support at least the electrode plate and the separator on both sides in a longitudinal direction.

3. The electrode assembly alignment inspection apparatus of claim 1, wherein the holder comprises a light-transmitting transparent member disposed in the plurality of holes.

4. The electrode assembly alignment inspection apparatus of claim 1, wherein the stacking table comprises a plurality of insertion holes into which the auxiliary lighting is inserted, and
the holder is disposed on the stacking table so that the plurality of holes overlap the plurality of insertion holes.

5. The electrode assembly alignment inspection apparatus of claim 4, wherein the holder comprises
a first hole exposing a boundary between the electrode plate and the separator in a longitudinal direction; and
a second hole exposing a boundary between the electrode plate and the separator in a width direction,
wherein the second hole includes a portion of the electrode plate and the separator, open in the width direction.

6. The electrode assembly alignment inspection apparatus of claim 5, wherein the stacking table comprises
a first insertion hole overlapping the first hole; and
a second insertion hole overlapping the second hole,
wherein the first insertion hole and the second insertion hole are formed to have an area larger than that of the first hole and the second hole, respectively.

7. An electrode assembly alignment inspection method, comprising:
a supply operation of supplying an electrode plate and a separator to an electrode table into which auxiliary lighting is inserted;
a support operation of supporting the electrode plate and the separator by disposing a holder on the stacking table;
a photographing operation in which a photographing unit photographs an edge region of the electrode plate and the separator; and
a determination operation of inspecting an alignment state of the electrode plate and the separator to determine whether the alignment state is defective,
wherein the holder includes a plurality of holes exposing a boundary between the electrode plate and the separator, and
in the support operation, the holder is disposed on the stacking table so that the plurality of holes overlap a position into which the auxiliary lighting is inserted.

8. The electrode assembly alignment inspection method of claim 7, wherein in the support operation,
the holder is disposed on the stacking table to support at least the electrode plate and the separator on both sides in a longitudinal direction.

9. The electrode assembly alignment inspection method of claim 7, wherein the holder comprises
a first hole exposing the boundary between the electrode plate and the separator in the longitudinal direction; and
a second hole exposing the boundary between the electrode plate and the separator in a width direction, and including a portion of the electrode plate and the separator, open in the width direction,
wherein in the support operation, the holder is disposed so that the open portion of the second hole coincides with the boundary of the separator.

10. The electrode assembly alignment inspection method of claim 7, wherein in the determination operation, when the alignment state of the electrode plate and the separator is determined to be defective, the supply of the electrode plate and the separator is stopped.

11. The electrode assembly alignment inspection method of claim 7, wherein the electrode plate comprises a cathode plate and an anode plate, and
in the supply operation, the cathode plate and the anode are alternately supplied to the stacking table with the separator interposed therebetween.

12. The electrode assembly alignment inspection method of claim 11, wherein the support operation and the photographing operation are performed with the cathode plate disposed in the uppermost position based on a stacking direction of the stacking table.

13. The electrode assembly alignment inspection method of claim 11, wherein the photographing unit is provided in a number corresponding to that of the holder, and
the photographing operation is performed on one or more regions in which the holder is disposed.

14. The electrode assembly alignment inspection method of claim 11, wherein the determination operation comprises an operation of recognizing a boundary of the anode plate from the image photographed in the photographing operation, and
when the boundary of the anode plate is not recognized, the alignment state of the electrode plate and the separator is determined to be defective.

15. The electrode assembly alignment inspection method of claim 11, wherein the determination operation comprises an operation of measuring a gap between a boundary of the anode plate and a boundary of the separator from the image photographed in the photographing operation, and
when the gap between the boundary of the anode plate and the boundary of the separator exceeds a preset range, the alignment state of the electrode plate and the separator is determined to be defective.

16. The electrode assembly alignment inspection method of claim 11, wherein the determination operation comprises an operation of measuring a gap between a boundary of the anode plate and a boundary of the cathode plate from the image photographed in the photographing operation, and
when the gap between the boundary of the anode plate and the boundary of the cathode plate exceeds a preset range, the alignment state of the electrode plate and the separator is determined to be defective.
